(19) United States
(12) Patent Application Publication
(10) Pub. No.: US 2024/0384577 A1
(43) Pub. Date: Nov. 21, 2024

(54) SLIDE LOCK

(71) Applicant: Endura Products, LLC, Colfax, NC (US)

(72) Inventors: Tomasz Jaskiewicz, Oak Ridge, NC (US); Stephen Simon, Winston-Salem, NC (US); Austin Mundy, Colfax, NC (US)

(73) Assignee: Endura Products, LLC, Colfax, NC (US)

(21) Appl. No.: 17/694,139

(22) Filed: Mar. 14, 2022

Related U.S. Application Data
(60) Provisional application No. 63/160,368, filed on Mar. 12, 2021.

(51) Int. Cl. E05C 19/00

(52) U.S. Cl. CPC E05C 19/001

(57) ABSTRACT

Door locking apparatus, systems, assemblies, kits and methods are shown and described. In one example, a lock assembly may include a hosing, a locking blade, and a handle. The door locking apparatus may align with a door frame assembly including a door panel, to secure the door in a locked position. In some examples, the locking blade is adapted to slidably overlap at least a portion of a non-hinged edge of a door panel to resist opening of the door panel.

This application claims the benefit of Provisional Application Ser. No. 63/160,368 filed Mar. 12, 2021.

### FIELD OF THE TECHNOLOGY

The present disclosure relates generally to locks, and more particularly to improved locks for a door assembly.

### BACKGROUND

Many entrance doors are secured by a deadbolt lock. While a deadbolt provides strong resistance to unwanted forced entry, its design concentrates force in one location. It is not uncommon for the door frame to break at the deadbolt location when force is applied against the door.

Further, intruders trying to force entry may expect deadbolt locks and expose the centralized force of deadbolt locks to force entry. Accessory locks can interfere with use of the door, be cumbersome, and/or expensive.

Therefore, Applicant desires systems and methods for a door lock to improve security and lock resistance, without interfering with regular door function, in an easy and economical manner.

### SUMMARY

In accordance with the present disclosure, lock devices, systems, kits and methods are provided for improving door security. This disclosure provides improved lock assemblies that are convenient, easy to use and install, and cost effective for the user, particularly when used to improve door security.

One embodiment of the present disclosure includes a lock assembly including a housing mountable adjacent to an interior side of a door unit, a locking blade at least partially mounted with the housing mount, and a handle adapted to facilitate a movement of the locking blade. The locking blade is adapted in this example to slidably overlap at least a portion of a non-hinged edge of a door panel to resist opening of the door panel. The locking blade may be a sliding locking blade.

In some examples, the housing and locking blade are vertically oriented along a substantial portion of a door frame on a non-hinged side of a door panel. The locking blade may be slidable in a horizontal direction. The locking blade may alternate between an engaged position and a non-engaged position, the locking blade overlapping the at least a portion of the non-hinged edge when in the engaged position. The housing may be mounted in a stationary position. The locking blade may overlap the housing in a non-engaged position.

A handle may recess into a handle slot.

In other examples, a door locking system may include a lock assembly. The lock assembly may include a housing for securing the assembly to the interior wall adjacent to a door frame, a blade movable between an engaged position and non-engaged position, and a handle for moving the blade between the engaged position and the non-engaged position. The door locking system may also include a door assembly. The door assembly may include a door panel having hinged edge and a non-hinged edge, and a door frame extending along the non-hinged edge of the door panel. The lock assembly is, in some examples, a two-piece assembly. A housing may be one piece of the two-piece assembly. The housing may be stationary and extend along a vertical axis along the door frame. The locking blade may be a second piece of the two-piece assembly and may be extendable from said housing to overlap with a door panel along the non-hinged edge. The locking blade may be retractable upon the housing and extendable to engage with a non-hinged door panel edge.

One example includes a vertically oriented locking device able to extend horizontally to secure a door against entry.

The door locking system may include a deadbolt lock. The door locking system may be an accessory door locking system. The door locking system may include an external lock located on an interior surface of a door frame.

Still another embodiment of the present disclosure includes a method for securing a door, a method for a door lock, and/or a kit for securing a door according to any or all of the embodiments as disclosed herein.

The above summary was intended to summarize certain embodiments of the present disclosure. Embodiments will be set forth in more detail in the figures and description of embodiments below. It will be apparent, however, that the description of embodiments is not intended to limit the present inventions, the scope of which should be properly determined by the appended claims.

### BRIEF DESCRIPTION OF THE DRAWINGS

Embodiments of the disclosure will be better understood by a reading of the Description of Embodiments along with a review of the drawings, in which:

FIG. 1 is a front view of a door lock assembly according to one embodiment of the disclosure;

FIG. 2 is a front view of the door lock assembly according to FIG. 1, and showing the lock engaged;

FIG. 3 is a close up view of a portion of the door lock assembly according to FIG. 2;

FIG. 4 is a front perspective view of a door system including a door lock assembly according to one embodiment of the disclosure;

FIG. 5A is a front perspective view of a door lock assembly according to one embodiment of the disclosure;

FIG. 5B is a back perspective view of a door lock assembly according to one embodiment of the disclosure of FIG. 5A;

FIGS. 5C-5D are end views of a door lock assembly according to one embodiment of the disclosure of FIG. 5A; and

FIG. 5E is an exploded view of a door lock assembly according to one embodiment of the disclosure of FIG. 5A.

### DESCRIPTION OF EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

Referring now to the drawings in general, it will be understood that the illustrations are for the purpose of describing embodiments of the disclosure and are not intended to limit the disclosure or any invention thereto.

One embodiment of the present disclosure includes a lock assembly 20 including a housing 22 mountable adjacent to an interior surface 17 of a door unit having a door panel 12, a locking blade 23 at least partially mounted with the housing 22 mount, and a handle 24 adapted to facilitate a movement of the locking blade 23. The locking blade 23 is adapted in this example to slidably overlap at least a portion of a non-hinged edge 12a of a door panel 12 to resist opening of the door panel. The locking blade 23 may be a sliding locking blade. One or more hinges 14 may secure the panel 12 on a hinged edge 12b to the door frame 16.

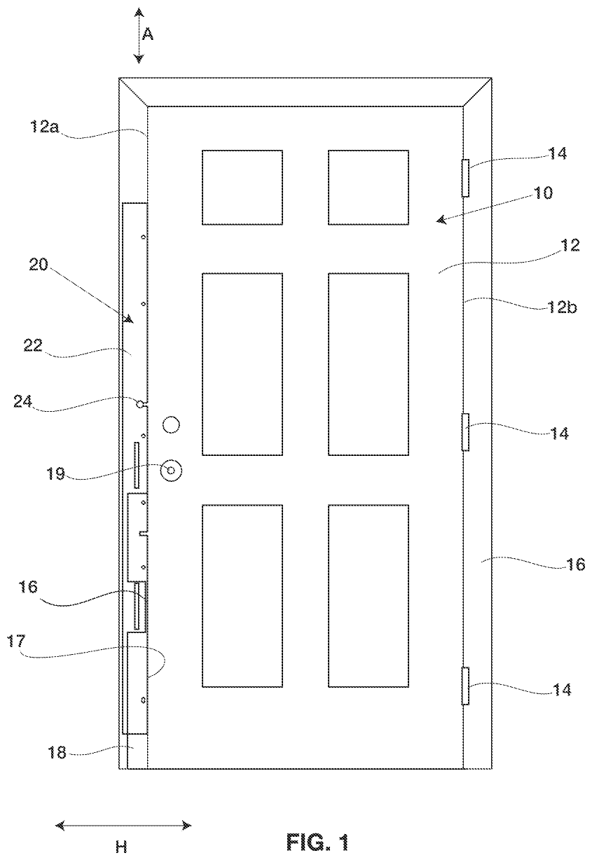

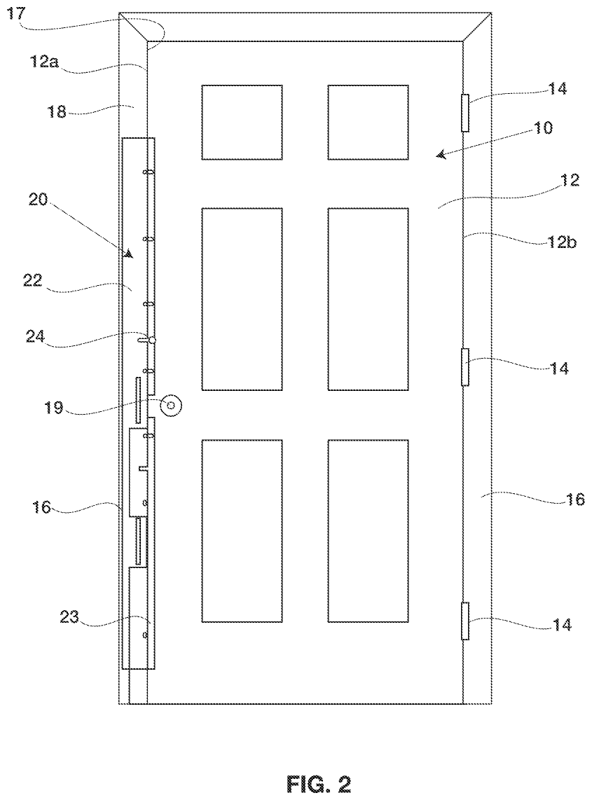

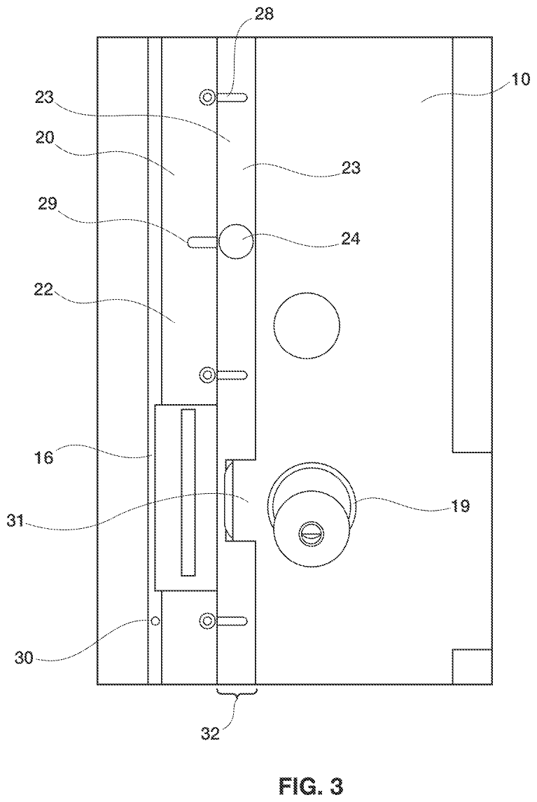

In some examples, the housing 22 and locking blade 23 are vertically oriented along a substantial portion of a door frame 16 on a non-hinged edge 12a of a door panel 12. The locking blade may be slidable in a horizontal direction H. The locking blade 23 may alternate between a non-engaged position (see FIG. 1) and an engaged position (See FIGS. 2 and 3), the locking blade 23 overlapping, and creating an overlapping edge 32, with the at least a portion of the non-hinged edge 12a when in the engaged position. The housing 22 may be mounted in a stationary position. The locking blade 23 may overlap the housing 22 in a non-engaged position.

A handle 24 may recess into a handle slot 29. The handle 24 may be a recess, a projection, a ledge, a raised area, etc. that allows leverage and/or gripping to be able to move the locking blade 23. The handle 24 may take on any shape. The handle 24 may be a part of the locking blade 23 and/or attached to the locking blade. A handle slot 29 may be a cutout in the housing 22. The handle 24 may recess into the handle slot 29 when the locking blade 23 recesses into or upon the housing 22. The handle 24 may release from the handle slot 29 when the locking blade 23 extends to form an overlapping edge 32 with the non-hinged edge 12a. Additional slots 28 may be located along the locking blade 23.

In other examples, a door locking system may include a lock assembly 20. The lock assembly 20 may include a housing 22 for securing the assembly to a door frame 16, a locking blade 23 movable between an engaged position and non-engaged position, and a handle 24 for moving the blade between the engaged position and the non-engaged position. The door locking system may also include a door assembly 10. The door assembly may include a door panel 12 having hinged edge 12b and a non-hinged edge 12a, and a door frame 16 extending along the non-hinged edge 12a of the door panel 12. The lock assembly is, in some examples, a two-piece assembly. A housing 22 may be one piece of the two-piece assembly. The housing 22 may be stationary and extend along a vertical axis A along the door frame 16. The housing 22 may be secured to the frame 16 by way of securing mechanisms 30, by way of example, screws, nails, bolts, staples, adhesive, etc. The locking blade 23 may be a second piece of the two-piece assembly and may be extendable from the housing 22 to overlap with a door panel 12 along the non-hinged edge 12a. The locking blade 23 may be retractable upon the housing 22 and extendable to engage with a non-hinged door panel edge 12a.

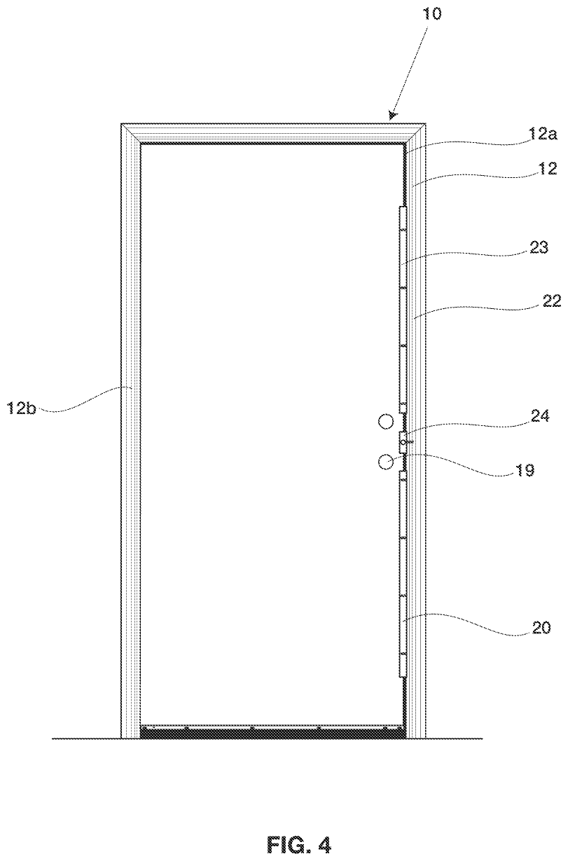

FIG. 4 shows a door assembly 10 including a lock assembly 20.

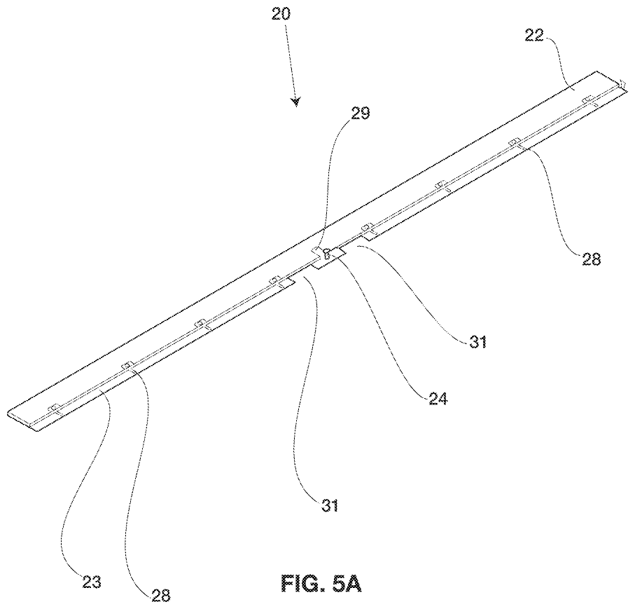

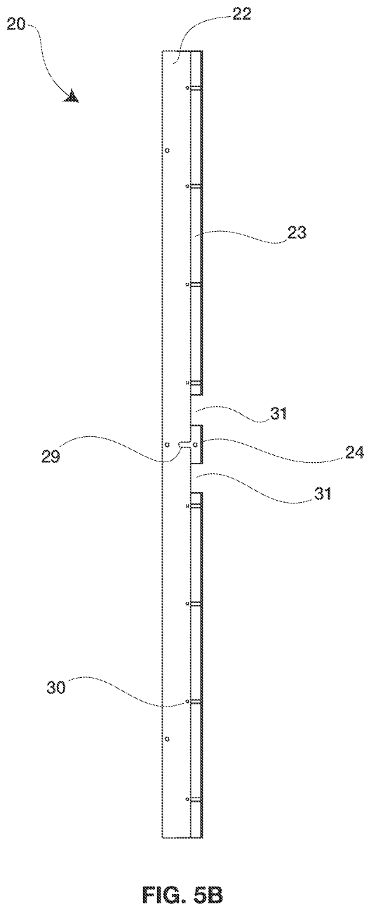

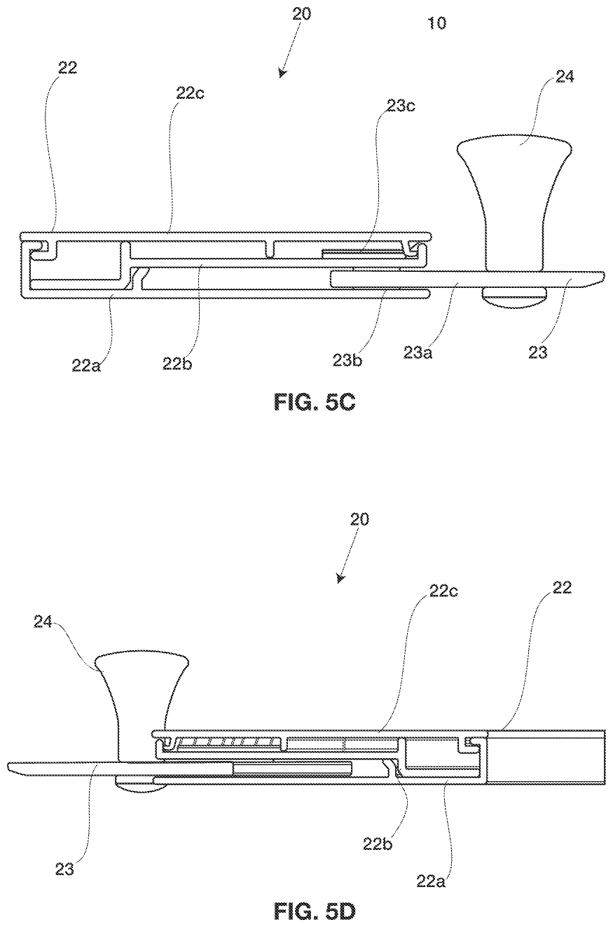

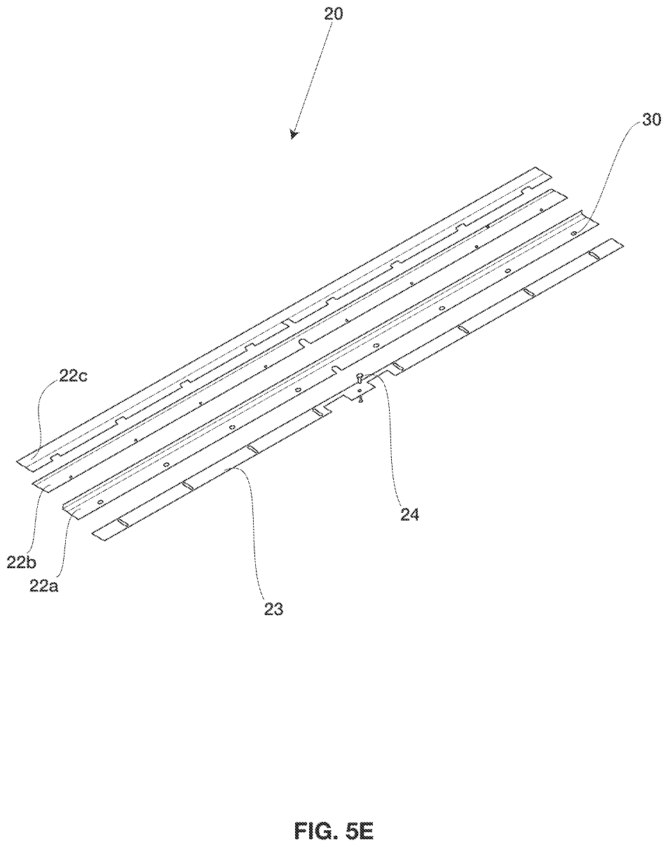

FIGS. 5A and 5B show examples of a lock assembly 20 in an engaged position.

FIGS. 5C-5D show alternate end views of a lock assembly 20. Lock assembly 20 may include a housing 22 with a base 22a, a top 22b, and a cover 22c. Examples of a locking blade 23 may include a blade portion 23a that is situated between a base 22a and a top 22b of the housing 22. A securing portion 23c may be attached to the blade portion 23a, in some examples, by way of arm 23b. Securing portion 23c may be housed between cover 22c and top 22b. Locking blade 23 may slide out from and recess within a space formed between base 22a and top 22b.

FIG. 5E shows an exploded view of an example of lock assembly 20.

One example includes a vertically oriented locking device, including a housing 22 and a locking blade 23 able to extend horizontally H to secure a door against entry by forming an overlapping edge 32.

The door locking system may include a deadbolt lock. The door locking system may be an accessory door locking system. The door locking system may include an external lock located on an inside surface 17 of a door frame. A blade notch 31 may occur along the locking blade 23. The blade notch 31 may be long the length of the locking blade, and in some examples around the door knob 19 area height.

In certain examples in use, embodiments of the invention may serve as a supplemental lock to a deadbolt. A housing 22 may be mounted on the interior surface 18 of the frame 16 at the deadbolt side and includes a vertical locking blade 23 that is slidably located within the housing 22. When the door panel 12 is closed, the locking blade 23 can be moved towards the door panel 12 in a horizontal direction H. The locking blade 23 overlaps the non-hinged edge 12a of the door panel 12 preventing the door panel 12 from being opened or forced open. Due to the length of the locking blade 23 and the overlapping edge 32 with the door panel 12, unwanted force on the panel 12 from the exterior side is spread out over an area larger than the point area found at the deadbolt location. In combination with a deadbolt this supplemental lock increases the resistance of a door assembly to unwanted entry.

Still another embodiment of the present disclosure includes a method for securing a door, a method for a door lock, and/or a kit for securing a door according to any or all of the embodiments as disclosed herein.

Numerous characteristics and advantages have been set forth in the foregoing description, together with details of structure and function. Many of the novel features are pointed out in the appended claims. The disclosure, however, is illustrative only, and changes may be made in detail, especially in matters of shape, size, and arrangement of parts, within the principle of the disclosure, to the full extent indicated by the broad general meaning of the terms in which the general claims are expressed. It is further noted that, as used in this application, the singular forms “a,” “an,” and “the” include plural referents unless expressly and unequivocally limited to one referent.

1-20. (canceled)

21. A lock assembly comprising:
a housing configured to secure to an interior side of a door frame adjacent a non-hinged edge of a door panel; and
a locking blade moveably mounted to the housing, the locking blade having an engaged state in which the locking blade overlaps a portion of a non-hinged edge of a door panel to prevent movement of the door panel from a closed position thereof,
wherein the housing comprises a single piece assembly having a base, a top and a cover.

22. The lock assembly according to claim 21, wherein the locking blade is slidingly mounted to the housing.

23. The lock assembly according to claim 21, wherein the housing and locking blade are configured to be vertically oriented along a substantial portion of the door frame.

24. The lock assembly according to claim 21, wherein the locking blade has a non-engaged state in which the door panel is free to move from the closed position, the locking blade sliding horizontally relative to the housing between the engaged state and the non-engaged state.

25. The lock assembly according to claim 24, wherein the locking blade is at least partially disposed within the housing in the non-engaged state.

26. The lock assembly according to claim 24, wherein the locking blade is fully disposed within the housing in the non-engaged state.

27. The lock assembly according to claim 21, further comprising a handle configured to facilitate movement of the locking blade relative to the housing.

28. The lock assembly according to claim 27, wherein the handle is a slot or a recess defined in the locking blade.

29. The lock assembly according to claim 27, wherein the handle is a projection, a ledge, or a raised area formed on the locking blade.

30. The lock assembly according to claim 27, wherein the handle formed separate from the locking blade, the handle being fixedly mounted to the locking blade.

31. A door assembly comprising:
a door frame;
a door panel having a hinged edge and a non-hinged edge opposite the hinged edge, the hinged edge pivotally mounted to the door frame, the door panel having a closed position in which the door panel is disposed in within the door frame and prevents ingress or egress through the door frame, the door panel having an open position in which the door panel is pivoted relative to the door frame such that ingress or egress through the door frame is permitted; and
a lock assembly according to claim 21, a housing of the lock assembly fixedly secured to an inside edge of the door frame adjacent the non-hinged edge of the door panel,
wherein the housing comprises a single piece assembly having a base, a top and a cover.

32. A door locking system comprising:
a lock assembly comprising:
a housing configured to mount to a door frame; and
a blade mounted to the housing, the blade moveable relative to the housing between an engaged state in which the blade is configured to prevent a door panel from pivoting from a closed position thereof and a non-engaged state in which the blade is configured to allow the door panel to pivot from the closed position,
wherein the housing comprises a single piece assembly having a base, a top and a cover.

33. The door locking system according to claim 32, wherein the blade is slidably mounted to the housing such that the blade slides horizontally between the engaged state and the non-engaged state.

34. The door locking system according to claim 32, wherein in the non-engaged state the blade is retracted within the housing.

35. The door locking system according to claim 34, wherein in the non-engaged state the blade is completely retracted within the housing.

36. The door locking system according to claim 32, wherein housing and the blade extend vertically and are dimensioned to extend along a substantial portion of a vertical non-hinged edge of the door panel.

37. The door locking system according to claim 32, further comprising:
a door frame, the housing mounted to the door frame; and
a door panel having a hinged edge and a non-hinged edge, the door panel pivotally mounted to the door frame along the hinged edge such that the door panel is pivotable between a closed position and an open position, the blade overlapping the non-hinged edge of the door panel when the door panel is in the closed position and the blade is in the engaged state.

38. The door locking system according to claim 37, further comprising a deadbolt locking system disposed within the door panel, the deadbolt locking system including a deadbolt having an extended state in which the deadbolt extends from the non-hinged edge into the door frame to prevent the door panel from pivoting from the closed position and a retracted state in which the deadbolt is retracted into the door panel from the extended state such that the door panel is allowed to pivot from the closed position.

39. A lock assembly comprising:
a housing configured to secure to a door frame such that the housing extends adjacent an unhinged edge of a door panel pivotally mounted to the door frame; and
a locking blade mounted to the housing, the locking blade having a non-engaged state in which the locking blade is configured to allow the door panel to pivot from a closed position thereof and an engaged state in which the locking blade is configured to prevent the door panel from pivoting from the closed position, the locking blade configured to overlap a substantial portion of the unhinged edge of the door panel in the engaged state,
wherein the housing comprises a single piece assembly having a base, a top and a cover.

40. The lock assembly according to claim 39, wherein the locking blade slides horizontally relative to the housing between the non-engaged state and the engaged state.
